(19) United States
(12) Patent Application Publication
(10) Pub. No.: US 2026/0028256 A1
(43) Pub. Date: Jan. 29, 2026

(54) TREATMENT AGENT FOR WATER QUENCHING AND SLAG FLUSHING OF YELLOW PHOSPHORUS SLAG USING REVERSE OSMOSIS CONCENTRATE (ROC) AND PREPARATION METHOD THEREOF

(71) Applicant: Guizhou Education University, Guiyang City (CN)

(72) Inventors: Mingsen DENG, Guiyang City (CN); Hengxiu YANG, Guiyang City (CN); Hujun SHEN, Guiyang City (CN); Xuefeng ZOU, Guiyang City (CN); Fushao LI, Guiyang City (CN); Qingqing WU, Guiyang City (CN); Ling CHEN, Guiyang City (CN)

(73) Assignee: Guizhou Education University, Guiyang City (CN)

(21) Appl. No.: 18/955,841

(22) Filed: Nov. 21, 2024

(30) Foreign Application Priority Data
Jul. 24, 2024 (CN) 202410993942.8

(51) Int. Cl. C02F 1/68; C02F 1/44; C02F 101/10; C02F 103/16

(52) U.S. Cl. CPC C02F 1/68; C02F 1/441; C02F 2101/105; C02F 2103/16

(57) ABSTRACT

A treatment agent for water quenching and slag flushing of a yellow phosphorus slag using reverse osmosis concentrate (ROC) and a preparation method thereof are provided. The treatment agent for water quenching and slag flushing of the yellow phosphorus slag using ROC includes the following components in mass percentage: 3% to 10% of a dispersant, 1% to 3% of a wetting agent, 3% to 10% of a scale inhibitor, 3% to 8% of a carbon steel corrosion inhibitor, 0.5% to 1% of a copper corrosion inhibitor, 5% to 25% of a complex cleaning agent, and water as a balance.

### CROSS REFERENCE TO RELATED APPLICATION

This patent application claims the benefit and priority of Chinese Patent Application No. 202410993942.8 filed with the China National Intellectual Property Administration on Jul. 24, 2024, the disclosure of which is incorporated by reference herein in its entirety as part of the present application.

### TECHNICAL FIELD

The present disclosure relates to the technical field of environmental protection agents, and in particular to a treatment agent for water quenching and slag flushing of a yellow phosphorus slag using reverse osmosis concentrate (ROC) and a preparation method thereof.

### BACKGROUND OF THE INVENTION

Yellow phosphorus is mainly produced by a blast furnace process and an electric furnace process. The electric furnace process for producing yellow phosphorus shows desirable product quality, high labor productivity, and low production cost. Yellow phosphorus slag, a high-temperature molten slag of about 1,400° C. to 1,500° C. discharged when the yellow phosphorus is produced by the electric furnace process, is formed by subjecting apatite, quartz, and coke to smelting and reaction (2Ca₃(PO₄)₂+6SiO₂+10C→6CaSiO₃+10CO↑+P₄↑) in an electric arc furnace at a high temperature of about 1,600° C. 1 ton of the yellow phosphorus produced may generate 8 tons to 10 tons of the yellow phosphorus slag. The slag needs to undergo water quenching. The water quenching includes feeding the high-temperature yellow phosphorus slag into a granulation tower, and rapid cooling with water to form a granulated slag-water mixture (70° C. to 90° C.). Slag-water separation is conducted through various separation processes (such as bottom filtration (OCP) method, RASA method, INBA method, TYNA method, and MTC method). Resulting separated water is cooled and recycled for slag flushing, thus forming a water cycle to complete the slag flushing of the yellow phosphorus slag. During the whole process, a large amount of water may be lost due to evaporation, so it is necessary to continuously add water to a slag flushing water system to maintain water balance. At present, fresh water (such as surface water) is generally used for slag flushing. Although scaling and corrosion problems of slag flushing system equipment are relatively common, they are not serious and generally do not seriously affect operation of the slag flushing system. With the strengthening of environmental protection regulations, many phosphorus industrial production enterprises are basically required to treat wastewater with zero emission. A large amount of wastewater is generated in various production links, such as coking wastewater, desulfurization wastewater, and wastewater from various process production links. These wastewaters need to be deeply treated for reuse, and finally reverse osmosis concentrate (ROC) may be generated, accounting for about 20% to 25% of the total wastewater. These ROCs also require subsequent treatment to achieve zero emission requirements. The ROC could be used as supplement water for the slag flushing of the yellow phosphorus slag, and some yellow phosphorus manufacturers have already started using the same. This process not only achieves the effect of wastewater resource utilization, but also saves the cost of replenishing fresh water, and at the same time achieves saving water, reducing costs, and increasing efficiency. However, ROC has a large amount of impurities, high turbidity and hardness, and relatively high content of chloride ions and sulfates. During the water quenching and slag flushing, the ROC is prone to scale formation in the slag flushing system, such as calcium scale and magnesium scale, which could block the pipelines. At the same time, the ROC may also cause serious corrosion to the slag flushing system equipment and produce a large amount of rust accumulation. These problems cause equipment, pipelines, valves, water pumps, and nozzles to be frequently damaged and replaced, seriously affecting the operation of the slag flushing system and reducing the production efficiency and safety of yellow phosphorus production. Therefore, the corrosion, scaling, and clogging caused by the ROC as the slag flushing water must be solved, and chemical treatment of concentrated salt-containing slag flushing water is necessary.

At present, when the ROC is used as a system for replenishing the slag flushing water of the yellow phosphorus slag, basically no water treatment technology is adopted to suppress scaling, corrosion, fouling and blockage problems. Patent 202110808928.2 introduced a treatment agent for slag flushing water of a blast furnace using wastewater. However, examples in this patent mainly adopt direct desulfurization wastewater as the slag flushing water, which is somewhat different from using the ROC. From the perspective of scaling, (hydroxyethylidene) diphosphonicacid (HEDP) and amino tris (methylene phosphonic acid) (ATMP) in this patented technology basically have a function of inhibiting the formation of calcium carbonate-calcium sulfate scale, but there is extremely limited effect of inhibiting the formation of silicate scale. As a result, although the hydrogen fluoride ammonia contained has a certain removal effect on the silica scale, the removal actually takes effect after the scale is formed, and cannot solve the fundamental problem of inhibiting the formation of silica scale, and there is not an ideal removal effect. More importantly, the corrosion may be highly serious for concentrated brine as the slag flushing water, such that it is very important to inhibit corrosion and remove rust. In this patented technology, basically only the HEDP could provide corrosion inhibition, while the aminosulfonic acid in the formula has a strong ability to clean carbonate sulfate scale but a poor ability to clean rust.

### SUMMARY OF THE INVENTION

In order to solve the problems existing in the prior art, the present disclosure is intended to provide a treatment agent for water quenching and slag flushing of a yellow phosphorus slag using ROC and a preparation method thereof. In the present disclosure, the treatment agent could effectively avoid scaling, corrosion, fouling and blockage caused by a harsh quality of a slag flushing water, and shows a desirable ability to clean rust.

To achieve the above objects, the present disclosure provides the following technical solutions.

The present disclosure provides a treatment agent for water quenching and slag flushing of a yellow phosphorus slag using ROC, including the following components in mass percentage:
3% to 10% of a dispersant, 1% to 3% of a wetting agent, 3% to 10% of a scale inhibitor, 3% to 8% of a carbon steel corrosion inhibitor, 0.5% to 1% of a copper corrosion inhibitor, 5% to 25% of a complex cleaning agent, and water as a balance; where
the scale inhibitor includes polyamino polyether methylene phosphonic acid (PAPEMP) and a dendritic polymer poly (amidoamine) (PAMAM);
the wetting agent includes polyethylene glycol (PEG);
the carbon steel corrosion inhibitor includes 2-hydroxyphosphonoacetic acid (HPAA);
the copper corrosion inhibitor includes 5-butyl-benzotriazole; and
the complex cleaning agent includes citric acid and formic acid.

In some embodiments, the dispersant is one or more selected from the group consisting of acrylic acid/2-acrylamide-2-methylpropanesulfonic acid copolymer (AA/AMPS), acrylic acid/2-hydroxypropyl acrylate copolymer (AA/HPA), and maleic acid/acrylic acid copolymer (MA/AA).

In some embodiments, a mass ratio of the PAPEMP to the dendritic polymer PAMAM is in a range of 3-5:1.

In some embodiments, a mass ratio of the citric acid to the formic acid is in a range of 0.5-2:1.

The present disclosure further provides a method for preparing the treatment agent described in the above technical solution, including the following steps:
mixing the dispersant, the wetting agent, the scale inhibitor, the carbon steel corrosion inhibitor, the copper corrosion inhibitor, the complex cleaning agent, and the water to obtain the treatment agent.

In some embodiments, the mixing is conducted by stirring at a rotating speed of 50 rpm to 500 rpm.

The present disclosure provides a treatment agent for water quenching and slag flushing of a yellow phosphorus slag using ROC, including the following components in mass percentage: 3% to 10% of a dispersant, 1% to 3% of a wetting agent, 3% to 10% of a scale inhibitor, 3% to 8% of a carbon steel corrosion inhibitor, 0.5% to 1% of a copper corrosion inhibitor, 5% to 25% of a complex cleaning agent, and water as a balance; where the scale inhibitor includes PAPEMP and a PAMAM; the wetting agent includes PEG; the carbon steel corrosion inhibitor includes HPAA; the copper corrosion inhibitor includes 5-butyl-benzotriazole; and the complex cleaning agent includes citric acid and formic acid. In the present disclosure, the citric acid has a strong cationic complexing ability, and could greatly increase the calcium and magnesium ion saturation of a slag flushing water, making it more difficult to scale. The PAPEMP has an extremely strong scale inhibition performance, which is much higher than that of HEDP and ATMP; the PAMAM also has the function of silicon scale inhibition. After the above two are combined, silicon scale inhibition ability becomes stronger, which leads to stronger inhibition of the formation of calcium carbonate scale, calcium sulfate scale, and silicate scale. The PEG has wettability and could reduce the surface tension of a metal, such that nucleated scaling grains are difficult to precipitate on the metal surface. A combination of the HPAA and the copper corrosion inhibitor 5-butyl-benzotriazole (BBT) could effectively improve the corrosion inhibition performance. The formic acid has a similar effect as aminosulfonic acid in cleaning calcium carbonate-calcium sulfate scale, and the citric acid enhances the rust removal function. A combination of the above two has desirable cleaning functions for rust, calcium carbonate, and silicate. In summary, the treatment agent provided by the present disclosure could effectively inhibit formation of a calcium carbonate-calcium sulfate-silicate scale and corrosion of various metals during the water quenching and slag flushing of yellow phosphorus slag, has an excellent rust removal effect, and could realize safe operation of a slag flushing water system to improve production efficiency. In addition, the treatment agent achieves anti-corrosion, anti-scaling, and anti-blocking in the slag flushing water system while consuming the ROC, thereby reducing pressure in zero emission of wastewater, and achieving saving water, reducing costs, and increasing efficiency.

### DETAILED DESCRIPTION OF THE EMBODIMENTS

The present disclosure provides a treatment agent for water quenching and slag flushing of a yellow phosphorus slag using ROC, including/consisting of the following components in mass percentage:
3% to 10% of a dispersant, 1% to 3% of a wetting agent, 3% to 10% of a scale inhibitor, 3% to 8% of a carbon steel corrosion inhibitor, 0.5% to 1% of a copper corrosion inhibitor, 5% to 25% of a complex cleaning agent, and water as a balance; where
the scale inhibitor includes PAPEMP and a PAMAM;
the wetting agent includes PEG; the carbon steel corrosion inhibitor includes HPAA;
the copper corrosion inhibitor includes 5-butyl-benzotriazole; and
the complex cleaning agent includes citric acid and formic acid.

In some embodiments of the present disclosure, the treatment agent includes 3% to 10%, and preferably 5% to 8% of the dispersant in mass percentage. In some embodiments of the present disclosure, the dispersant includes one or more selected from the group consisting of AA/AMPS, AA/HPA, and MA/AA, and preferably the AA/AMPS.

In some embodiments of the present disclosure, the treatment agent includes 1% to 3%, and preferably 2% of the wetting agent in mass percentage. In some embodiments of the present disclosure, the wetting agent includes PEG. In some embodiments of the present disclosure, the PEG has a weight-average molecular weight of 200 to 600, preferably 200, 400, 600, and more preferably 200.

In some embodiments of the present disclosure, the treatment agent includes 3% to 10%, and preferably 5% to 8% of the scale inhibitor in mass percentage. In some embodiments of the present disclosure, the scale inhibitor includes PAPEMP and a PAMAM. In some embodiments of the present disclosure, a mass ratio of the PAPEMP to the PAMAM is in a range of 3-5:1, and preferably 4:1.

In some embodiments of the present disclosure, the treatment agent includes 3% to 8%, and preferably 5% of the carbon steel corrosion inhibitor in mass percentage. In some embodiments of the present disclosure, the carbon steel corrosion inhibitor includes HPAA.

In some embodiments of the present disclosure, the treatment agent includes 0.5% to 1%, and preferably 0.6% to 0.8% of the copper corrosion inhibitor in mass percentage. In some embodiments of the present disclosure, the copper corrosion inhibitor includes 5-butyl-benzotriazole.

In some embodiments of the present disclosure, the treatment agent includes 5% to 25%, and preferably 10% to 20% of the complex cleaning agent in mass percentage; the complex cleaning agent includes citric acid and formic acid. In some embodiments of the present disclosure, a mass ratio of the citric acid to the formic acid is in a range of 0.5-2:1, and preferably 1:1.

The present disclosure further provides a method for preparing the treatment agent described in the above technical solution, including the following steps:
mixing the dispersant, the wetting agent, the scale inhibitor, the carbon steel corrosion inhibitor, the copper corrosion inhibitor, the complex cleaning agent, and the water to obtain the treatment agent.

In some embodiments of the present disclosure, the mixing is conducted by stirring. In some embodiments of the present disclosure, the stirring is conducted at a rotating speed of 50 rpm to 500 rpm, and preferably 50 rpm to 200 rpm. In some embodiments of the present disclosure, the mixing is conducted until all solids are dissolved.

The technical solutions provided by the present disclosure will be described in detail below with reference to examples, but the examples should not be understood as limiting the scope of the present disclosure.

### Example 1

A treatment agent for water quenching and slag flushing of a yellow phosphorus slag using ROC consisted of the following components in mass percentage:
4% of AA/AMPS;
1% of PEG200;
3% of a mixture of PAPEMP and a PAMAM (a mass ratio of the PAPEMP to the PAMAM being 4:1);
3% of HPAA;
0.5% of 5-butyl-benzotriazole;
17% of a mixture of citric acid and formic acid (a mass ratio of the citric acid to the formic acid being 1:1); and
a balance being water.

### Preparation Method

The above raw materials were mixed and stirred at 100 rpm until all solids were dissolved to obtain the treatment agent.

### Example 2

A treatment agent for water quenching and slag flushing of a yellow phosphorus slag using ROC consisted of the following components in mass percentage:
8% of a mixture of AA/AMPS and AA/HPA; where a mass ratio of the AA/AMPS to the AA/HPA in the mixture of AA/AMPS and AA/HPA was 1:1;
2.5% of PEG400;
8% of a mixture of PAPEMP and a PAMAM (a mass ratio of the PAPEMP to the PAMAM being 4:1);
6% of HPAA;
1% of 5-butyl-benzotriazole;
25% of a mixture of citric acid and formic acid (a mass ratio of the citric acid to the formic acid being 1:1); and
a balance being water.

### Preparation Method

The above raw materials were mixed and stirred at 150 rpm until all solids were dissolved to obtain the treatment agent.

### Test Example 1

A ROC water quality of a yellow phosphorus production enterprise was used to simulate water quenching. The ROC water quality consisted of: calcium ions 850 mg/L, magnesium ions 480 mg/L, total alkalinity 300 mg/L, chloride ions 480 mg/L, sulfates 1200 mg/L, total phosphorus: 3 mg/L, SiO₂: 120 mg/L, turbidity 0.6 NTU. The agent prepared in Example 1 was used for a circulation simulation test, with a dosage of about 600 mg/L.

Effect: at a water temperature of about 90° C., rust on a rusted carbon steel hanging piece was basically removed, and an original carbon steel hanging piece has no obvious corrosion. A corrosion inhibition rate of the original carbon steel hanging piece is 96%, and a corrosion inhibition rate of a copper hanging piece is 99.7%. There is no obvious scale attachment on a surface of the hanging piece. The water body is relatively clear, with a turbidity of 2.5 NTU, and there is no scale attachment on the bottom and wall of a tank.

NOTE: in the simulation experiment of the test example, the rusted carbon steel hanging piece, the original carbon steel hanging piece, and the copper hanging piece were used to simulate equipment materials that might be touched during the water quenching.

### Test Example 2

A ROC water quality of a yellow phosphorus production enterprise was used to simulate water quenching of a yellow phosphorus slag. The ROC water quality consisted of: calcium ions 550 mg/L, magnesium ions 280 mg/L, total alkalinity 200 mg/L, chloride ions 1,200 mg/L, sulfates 10,000 mg/L, SiO₂: 80 mg/L, turbidity 0.6 NTU. The agent prepared in Example 2 was used for a circulation simulation test, with a dosage of about 300 mg/L.

Effect: at a water temperature of about 90° C., rust on a rusted carbon steel hanging piece was basically removed, and an original carbon steel hanging piece has no obvious corrosion. A corrosion inhibition rate of the original carbon steel hanging piece is 95%, and a corrosion inhibition rate of a copper hanging piece is 99.5%. There is no obvious scale attachment on a surface of the hanging piece. The water body has high clarity, with a turbidity of 2.1 NTU, and there is no obvious scale attachment on the bottom and wall of a tank.

### Comparative Example 1

A ROC water quality of a yellow phosphorus production enterprise was used to simulate slag flushing and water quenching. The ROC water quality included: calcium ions 850 mg/L, magnesium ions 480 mg/L, total alkalinity 400 mg/L, chloride ions 480 mg/L, sulfates 1,200 mg/L, total phosphorus: 3 mg/L, SiO₂: 120 mg/L, turbidity 0.6 NTU. The agent was not added.

Effect: at a water temperature of about 90° C., a rusted carbon steel hanging piece is more seriously corroded, an original carbon steel hanging piece is seriously corroded, there is obvious scale adhesion on a surface, the water body is turbid, the turbidity is 67 NTU, and there is obvious scale adhesion on the bottom and wall of a tank.

Although the present disclosure is described in detail in conjunction with the foregoing examples, they are only a part of, not all of, the embodiments of the present disclosure. Other embodiments can be obtained based on these embodiments without creative efforts, and all of these embodiments shall fall within the scope of the present disclosure.

What is claimed is:

1. A treatment agent for water quenching and slag flushing of a yellow phosphorus slag using reverse osmosis concentrate (ROC), comprising the following components in mass percentage: 3% to 10% of a dispersant, 1% to 3% of a wetting agent, 3% to 10% of a scale inhibitor, 3% to 8% of a carbon steel corrosion inhibitor, 0.5% to 1% of a copper corrosion inhibitor, 5% to 25% of a complex cleaning agent, and water as a balance; wherein
the scale inhibitor comprises polyamino polyether methylene phosphonic acid (PAPEMP) and a dendritic polymer poly (amidoamine) (PAMAM);
the wetting agent comprises polyethylene glycol (PEG);
the carbon steel corrosion inhibitor comprises 2-hydroxyphosphonoacetic acid (HPAA);
the copper corrosion inhibitor comprises 5-butyl-benzotriazole; and
the complex cleaning agent comprises citric acid and formic acid.

2. The treatment agent of claim 1, wherein the dispersant is one or more selected from the group consisting of acrylic acid/2-acrylamide-2-methylpropane sulfonic acid copolymer (AA/AMPS), acrylic acid/2-hydroxypropyl acrylate copolymer (AA/HPA), and maleic acid/acrylic acid copolymer (MA/AA).

3. The treatment agent of claim 1, wherein a mass ratio of the PAPEMP to the PAMAM is in a range of 3-5:1.

4. The treatment agent of claim 1, wherein a mass ratio of the citric acid to the formic acid is in a range of 0.5-2:1.

5. A method for preparing the treatment agent of claim 1, comprising the following steps:
mixing the dispersant, the wetting agent, the scale inhibitor, the carbon steel corrosion inhibitor, the copper corrosion inhibitor, the complex cleaning agent, and the water to obtain the treatment agent.

6. The method of claim 5, wherein the mixing is conducted by stirring at a rotating speed of 50 rpm to 500 rpm.

7. The method of claim 5, wherein the dispersant is one or more selected from the group consisting of acrylic acid/2-acrylamide-2-methylpropane_sulfonic acid copolymer (AA/AMPS), acrylic acid/2-hydroxypropyl acrylate copolymer (AA/HPA), and maleic acid/acrylic acid copolymer (MA/AA).

8. The method of claim 5, wherein a mass ratio of the PAPEMP to the PAMAM is in a range of 3-5:1.

9. The method of claim 5, wherein a mass ratio of the citric acid to the formic acid is in a range of 0.5-2:1.
